(19) United States
(12) Patent Application Publication
(10) Pub. No.: US 2004/0014444 A1
(43) Pub. Date: Jan. 22, 2004

(54) Radio link adaptation method and control unit implementing the method

(75) Inventors: Nidham Ben Rached, Paris (FR); Stephane Cayla, Viroflay (FR)

Correspondence Address: Michael L. Kenaga, PIPER RUDNICK, P.O. Box 64807, Chicago, IL, 60664-0807, US

(73) Assignee: Nortel Networks Limited

(21) Appl. No.: 10/449,983

(22) Filed: May 30, 2003

(30) Foreign Application Priority Data
Jun. 3, 2002 (FR) FR 02 06786

(51) Int. Cl. H04B 17/02

(52) U.S. Cl. 455/135

(57) ABSTRACT

Radio links support signals, representing data blocks composed of symbols, transmitted between base stations and mobile stations by applying a transmission errors protection scheme selected from several specified protection schemes. Some at least of said stations communicate to a control unit measurement values relating to errors observed in the reception of symbols transmitted, and the control unit consults at least one lookup table to adaptively select the protection scheme applied to each radio link as a function of the measurement values communicated in relation to said link. For at least one of the protection schemes, statistical parameters relating to errors observed in the reception of blocks transmitted by applying said protection scheme are estimated. The estimated statistical parameters are processed so as to update the lookup table.

### BACKGROUND OF THE INVENTION

The present invention relates to the adaptation of radio links between base stations and mobile stations, in radio communication systems offering a plurality of protection levels for the data exchanged. It relates more particularly to the choice and the activation of a coding and/or of a modulation for such links.

Radio communication systems with multiple coding and/or modulations are known. The GPRS (General Packet Radio Service) system for example makes it possible to transmit, between a base station and a mobile station, modulated-signal blocks which can form the subject of variable protection against transmission errors. The level of protection is selected block by block by choosing a coding scheme CS from among four schemes CS-1 to CS-4 specified in the ETSI EN 300 909 European standard, Digital cellular telecommunications system (Phase 2+); Channel coding (GSM 05.03, version 8.5.1, Release 1999), published by the ETSI (European Telecommunications Standards Institute) in November 2000. Moreover, a single modulation is available in the GPRS system: two-state Gaussian minimum shift keying (GMSK).

Another possibility is to vary the level of protection by choosing a modulation of greater or lesser robustness: for a given duration of symbol in the modulated signal, a binary modulation, for example, will afford more protection than a quaternary or 8-ary modulation.

An extension of the GPRS system called EGPRS (Enhanced GPRS) uses, in addition to GMSK, eight-state phase shift keying (8-PSK) modulation. In EGPRS, nine modulation and coding schemes, called MCS-1 to MCS-9, are provided for. Each of these schemes makes it possible to offer a level of data protection of greater or lesser robustness and a higher or lower throughput.

A control unit, called the PCU (Packet Control Unit) in the aforesaid systems, is responsible for the choice of a modulation and coding scheme. This choice may be based on optimization of the throughput offered for each transmission and must take into account the conditions of the transmission between the stations concerned. Thus, if the quality of transmission is mediocre over the radio channels used, it will be preferable to use a robust scheme to ensure the transmission of the data. On the other hand, if the propagation conditions are not marred by errors, it will be judicious to choose a scheme favoring the data transmission throughput.

To do this, the control unit may be based on a certain number of measurements representative of the quality of transmission, which are dispatched to it by the base stations in respect of the radio uplinks (mobile station to base station), and/or by the mobile stations in respect of the radio downlinks (base station to mobile station).

However, the standard gives no indication as to the manner of selecting a coding and modulation scheme from among the schemes available in the technology envisaged (the 9 schemes for example in EGPRS) based on the quality measurements of the radio links. Neither is anything suggested in respect of the choice of measurements to be taken into account by the control unit.

Finally, the measurements made may have very relative values as a function for example of the sensitivity of the receiver which performs them, or else propagation characteristics related to the surroundings (urban, rural environment, etc.). Thus, raw measurements of quality of the radio links, such as bit error rates conventionally used in such systems, will not always be able to serve as basis for a characterization of the maximum throughput to be achieved. Hence a change of modulation and/or of coding will not be decidable, in a totally reliable manner, from simple values of measurement of the quality of radio links.

An object of the present invention is to improve the throughput of radio transmission by choosing a scheme for protection against transmission errors, for example a coding of the data and/or a modulation of the signals, which is adapted to the radio links used.

Another object of the invention is to define radio measurements to be taken into account by a control unit so as to select a protection scheme.

Still another object is to adapt the elements of choice of a coding scheme to the characteristics of the transmission and to calibrate these elements of choice by, taking into account observations characteristic of the useful throughput over relatively long time periods.

### SUMMARY OF THE INVENTION

The invention thus proposes a method for adapting radio links supporting signals, representing data blocks composed of symbols, transmitted between base stations and mobile stations by applying a transmission errors protection scheme selected from a plurality of specified protection schemes. At least some of said stations communicate to a control unit measurement values relating to errors observed in the reception of symbols transmitted, and the control unit consults at least one lookup table to adaptively select the protection scheme applied to each radio link as a function of the measurement values communicated in relation to said link. The method comprises the steps of:

for at least one of the protection schemes, estimating statistical parameters relating to errors observed in the reception of blocks transmitted by applying said protection scheme; and

processing the estimated statistical parameters to update the lookup table.

The transmission errors protection scheme may represent a coding of the data or a modulation of the signals, or else a coding/modulation pair.

The data blocks exchanged typically consist of bits. The measurement values relating to errors observed in the reception of symbols transmitted may comprise an averaged bit error rate and/or a a bit error probability variation parameter.

Several lookup tables may be stored by a control unit, for example one for each type of modulation available in the system. Thus, in EGPRS, the PCU will be able to maintain a table for the 8-PSK modulation and another for the GMSK modulation. It may manage one table or more, for example, one for radio uplinks and another for radio downlinks. It can also manage tables for each base station, i.e. for the links dependent on a given base station.

The updating of the lookup tables is performed by virtue of an evaluation which may be slower than the measurements related to the errors in the symbols transmitted and of an analysis of statistical parameters relating to errors observed in the reception of blocks transmitted. This makes it possible to calibrate the lookup tables as a function of parameters which are more representative of the useful throughput than the straightforward measurements relating to errors observed in the reception of symbols transmitted. This also makes it possible, advantageously, to take into account, automatically, certain specifics of the transmissions, for example related to the quality of the receivers or to the propagation conditions depending on the type of environment.

The updating of the lookup tables may be achieved by virtue of the analysis of distributions of the statistical parameters relating to errors observed in the reception of blocks transmitted, for two, for example consecutive, protection schemes (MCS-n and MCS-(n+1)). An estimation of an overlap between the two distributions may then make it possible to modify the lookup table concerned by translating for example the transition line between the two schemes in the table, so as to favor the presence of one of the schemes to the detriment of the other.

The invention also proposes a control unit for a radio communication system affording radio links supporting signals, representing data blocks composed of symbols, transmitted between base stations and mobile stations by applying a transmission errors protection scheme selected from a plurality of specified protection schemes. According to the invention, the control unit comprises:

means for reception, from certain at least of said stations, measurement values relating to errors observed in the reception of symbols transmitted;

means for consulting at least one lookup table for adaptively selecting the protection scheme applied to each radio link as a function of the measurement values received in relation to said link;

means for estimating, for at least one of the protection schemes, statistical parameters relating to errors observed in the reception of blocks transmitted by applying said protection scheme; and

means for updating the lookup table on the basis of the estimated statistical parameters.

### BRIEF DESCRIPTION OF THE DRAWINGS

FIG. 1 is a diagram of a GPRS type network to which the invention may be applied.

FIG. 2 is an exemplary schematic diagram of a packet control unit of such a network.

FIGS. 3A and 3B are diagrammatic representations of lookup tables usable in an embodiment of the invention.

FIG. 4 is a graph illustrating distributions of erroneous block rates involved in an embodiment of the invention.

FIG. 5 is a diagrammatic representation of upper parts of lookup tables before and after modification according to an embodiment of the invention.

### DESCRIPTION OF PREFERRED EMBODIMENTS

The invention is described below in its nonlimiting application to GPRS or EGPRS type networks. These networks have been developed to allow the transmission of data in packet mode in GSM (Global System for Mobile Communications) type cellular networks.

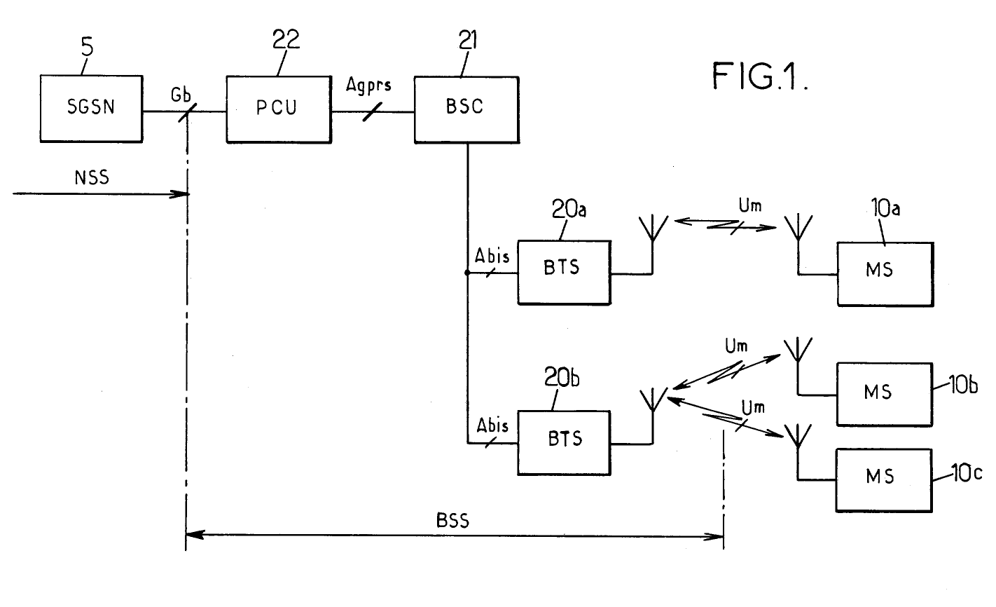

The GPRS network illustrated in FIG. 1 is built on a GSM infrastructure, and conventionally divided into a core network, also called Network and Switching Subsystem or NSS, and a radio-access network also called Base Station Subsystem or BSS.

For the packet service, the switches of the GPRS NSS are called GPRS support nodes or GSNs. A distinction is made between the SGSNs (Serving GSNs) 5 which are linked to the BSS by way of an interface called Gb, and the GGSNs (Gateway GSNs, not represented) which serve as a gateway with external packet transmission networks, such as the Internet, for example.

A general description of the radio interface, called Um, between the mobile stations (MS) 10a-10b-10c and the base stations (BTS) 20a-20b of the BSS is provided in the technical specification ETSI TS 101 350, “Digital cellular telecommunications system (Phase 2+); General Packet Radio Service (GPRS) ; Overall description of the GPRS radio interface; Stage 2 (GSM 03.64, version 8.5.0, Release 1999)”, published by ETSI (European Telecommunications Standards Institute) in August 2000.

Each base station 20a-20b is supervised by a base station controller or BSC 21 through an interface called Abis. In order to manage the transmission of GPRS packets, the BSS further comprises a packet control unit or PCU 22. The location of the PCU within the BSS is not standardized. In the example represented in FIG. 1, the PCU 22 is situated between the BSC 21, with which it communicates via an interface called Agprs, and the NSS, with which it communicates via the Gb interface.

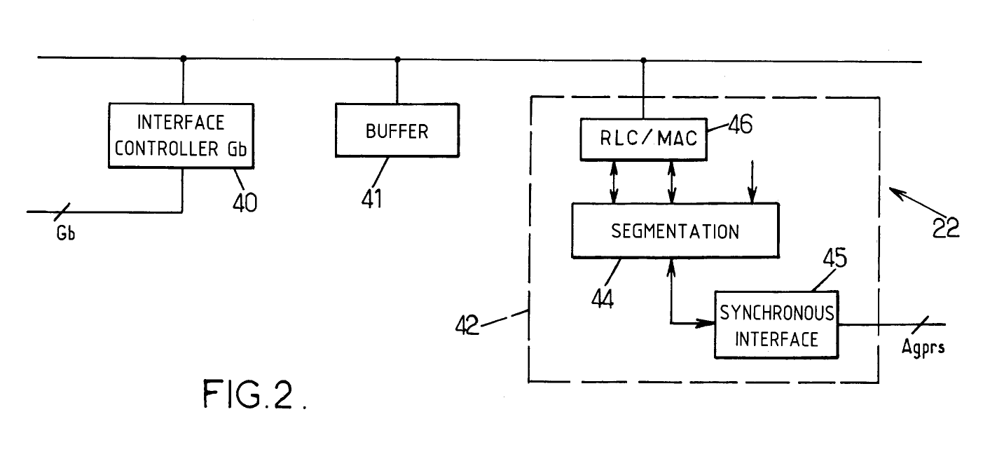

FIG. 2 illustrates a possible structure of a PCU 22 situated between an SGSN 5 and a BSC 21, as in the example of FIG. 1. The reference 40 designates the Gb interface controller for the link with the SGSN 5.

The Gb interface is of asynchronous type. It is based on the frame relay (FR) protocol, as well as on a protocol called BSSGP (BSS GPRS Protocol) which transports routing and quality-of-service information between the BSS and the SGSN. The Gb interface controller 40 provides the physical link with the SGSN 5, as well as carrying out the procedures specific to the FR and BSSGP protocols.

The links between the PCU 22 and the BTSs 20a-20b via the Agprs interface are of synchronous type. Consequently, the data manipulated by the PCU 22 between the Gb interface controller 40 and the Agprs interface controller 42 transit via a buffer memory 41 where packet queues are recorded.

Between the PCU 22 and the BTS 20a-20b, the information is carried by 320-bit frames of TRAU (Transcoder/Rate Adapter Unit) type. These TRAU frames are formatted and processed by a module 44 and transmitted by way of synchronous interface circuits 45 which form 16-kbit/s PCM subpaths with the BTSs 20a-20b. Several 16-kbit/s channels (subpaths) are time multiplexed on the. Agprs interface and switched by the BSC 21 for routing to the BTSs.

A module 46 of the Agprs interface controller 42 implements the radio protocols of layer 2 of the OSI model, i.e. the RLC/MAC (Radio Link Control/Medium Access Control) protocols described in the European Standard ETSI EN 301 349, “Digital cellular telecommunications system (Phase 2+); General Packet Radio Service (GPRS); Mobile Station (MS)—Base Station System (BSS) interface; Radio Link Control/ Medium Access Control (RLC/MAC) protocol (GSM 04.60, version 8.3.1, Release 1999)”, published by ETSI in October 2000.

The RLC sublayer forms the interface with the upper-layer protocol, called LLC (Logical Link Control). It carries out the segmentation and the reassembling of LLC protocol data units (LLC-PDUs), which are exchanged asynchronously on the Gb interface. It produces RLC data blocks to which the MAC sublayer adds a one-byte MAC header.

The MAC sublayer further manages the multiplexing of the blocks pertaining to the various temporary block flows (TBF) which are active on the physical channels available, by arbitrating between the various mobile users through a scheduling mechanism.

The RLC/MAC blocks format used in an EGPRS system is described in the aforesaid ETSI EN 301 349 European standard. Nine modulation and coding schemes, called MCS-1 to MCS-9, are provided for. They correspond to schemes for protection against transmission errors. The scheme used for a given block, as well as a puncturing scheme that may be applied, are indicated in a CPS (Coding and Puncturing Scheme indicator) field of the RLC/MAC EGPRS header. Each RLC block contains a number of bytes dependent on the modulation and coding scheme adopted for this block.

The entire EGPRS RLC/MAC header is subjected to a channel coding distinct from that of the data of the block. The level of protection of this header against transmission errors is higher than that of the data so as to ensure better robustness of the signaling information.

Table 1 indicates, for each protection scheme MCS-1 to MCS-9 of an EGPRS system, the modulation type used, the rate of the coding used (after puncturing) and also the resulting useful throughput. The data of this table emanate from the aforesaid ETSI TS 101 350 technical specification.

TABLE 1

| | | | Throughput |
|---|---|---|---|
| Scheme | Modulation | Coding rate | (kbit/s) |
| MCS-1 | GMSK | 0.53 | 8.8 |
| MCS-2 | GMSK | 0.66 | 11.2 |
| MCS-3 | GMSK | 0.80 | 14.8 |
| MCS-4 | GMSK | 1 | 17.6 |
| MCS-5 | 8-PSK | 0.37 | 22.4 |
| MCS-6 | 8-PSK | 0.49 | 29.6 |
| MCS-7 | 8-PSK | 0.76 | 44.8 |
| MCS-8 | 8-PSK | 0.92 | 54.4 |
| MCS-9 | 8-PSK | 1 | 59.2 |

It should be noted that in MCS-7, MCS-8 and MCS-9, two RLC/MAC blocks are mapped on a 20 ms radio block. Thus, the “data block” from which a radio block may be formed, and which must be able to transmitted from the PCU to the BTS at a frequency of one block every 20 ms per physical channel, can comprise several RLC/MAC blocks. It also comprises various items of control information useful to the BTS for the formation of the radio block, in particular the designation of the coding and/or modulation scheme to be applied.

The coding and modulation scheme applied is determined by the PCU as a function of measurements of quality of reception on the radio link. In the prior art, this is carried out according to link adaptation mechanisms which seek to achieve an objective in terms of erroneous block rates so as to optimize the raw throughput. The scheme selected is inserted into the TRAU frame bearing the block so as to be applied by the BTS in the downlink case. It is transmitted to an MS in a PACKET UPLINK ACK/NACK message in the uplink case.

The TS 100 911 technical specification, version 8.13.0, Digital cellular telecommunications system (Phase 2+); Radio Subsystem Link Control (3GPP TS 05.08 Release 1999), published in February 2002 by the 3GPP (3^{rd} Generation Partnership Project) organization describes the radio measurements to be carried out by the BTS and the MS on signals received. These measurements group together levels and indicators of quality of the signals. Among the latter, the EGPRS system provides for the calculation by an MS, on a downlink and for each of the two modulations (GMSK and 8-PSK), of indicators related to the bit error probability (BEP) over a radio block. Among these feature, in particular, the MEAN_BEP which is an average of the bit error probability over a radio block, and the CV_BEP which is a coefficient of variation of the bit error probability over a radio block, i.e.

$$CV\_BEP = \frac{\sqrt{variance ( BEP )}}{MEAN\_BEP} .$$

The values of MEAN_BEP and CV_BEP are averaged while taking into account a forgetting factor, as described in section 10.2.3.2 of the aforesaid TS 100 911 technical specification. They also take into account the set of channels (timeslots) allotted for the MS considered. Subsequently, the notation MEAN_BEP and CV_BEP is considered to apply to the averaged values.

Although not explicitly provided for by the standard, it is envisaged, in the present invention, that a BTS will calculate the same type of indicators MEAN_BEP and CV_BEP for radio uplinks. The MEAN_BEPs are coded on values lying between 0 and 31 and the CV_BEPs on values lying between 0 and 7. It may also be noted that the coding of the MEAN_BEPs differs depending on whether they are evaluated on one or the other of the two modulations available in the EGPRS system.

The measurements made by the MS (for example the MS 10a of FIG. 1) are sent back up to the PCU 22 in a PACKET DOWNLINK ACK/NACK message, as specified in paragraph 11.2.6a of the aforesaid EN 301 349 standard. The measurements made by the BTS (for example the BTS 20a of FIG. 1) are, for their part, transmitted to the PCU 22 in a TRAU frame.

The PCU 22 is responsible for selecting a coding and modulation scheme for each radio link, on the basis of the measurements which have been sent back up to it. Lookup tables are available to it which give a mapping between a pair (MEAN_BEP, CV_BEP) and one of the schemes MCS-1 to MCS-9. These tables therefore contain 256 (=32 MEAN_BEP * 8 CV_BEP) values of MCS. They may be applied to uplinks or to downlinks. They may also relate to all the BTSs (20a-20b), i.e. to all the radio links, either up, or down, under the dependence of the BTSs, or else a given BTS (20a) under the responsibility of the PCU 22. They can contain predetermined values which may possibly be dependent on certain criteria such as a propagation model (urban, rural, etc.). The PCU preferably maintains two tables for a BTS, namely one for each modulation.

Advantageously, the predetermined values with which the tables are initialized, emanate from simulations so that the coding and modulation scheme assigned to a pair (MEAN_BEP, CV_BEP) is that which makes it possible to offer the best possible theoretical throughput on the radio uplink or downlink considered. It is possible to envisage that certain protection schemes may never be recommended whatever the measured values of MEAN_BEP and CV_BEP. In this case, the corresponding schemes will be absent from the lookup tables concerned. Furthermore, values of MCS corresponding to 8-PSK modulation may be indicated for a pair (MEAN-BEP, CV_BEP) calculated with the GMSK modulation, and vice versa. In such a case, the modulation used for the communication will be modified on the link concerned during the change of MCS instructed by the PCU.

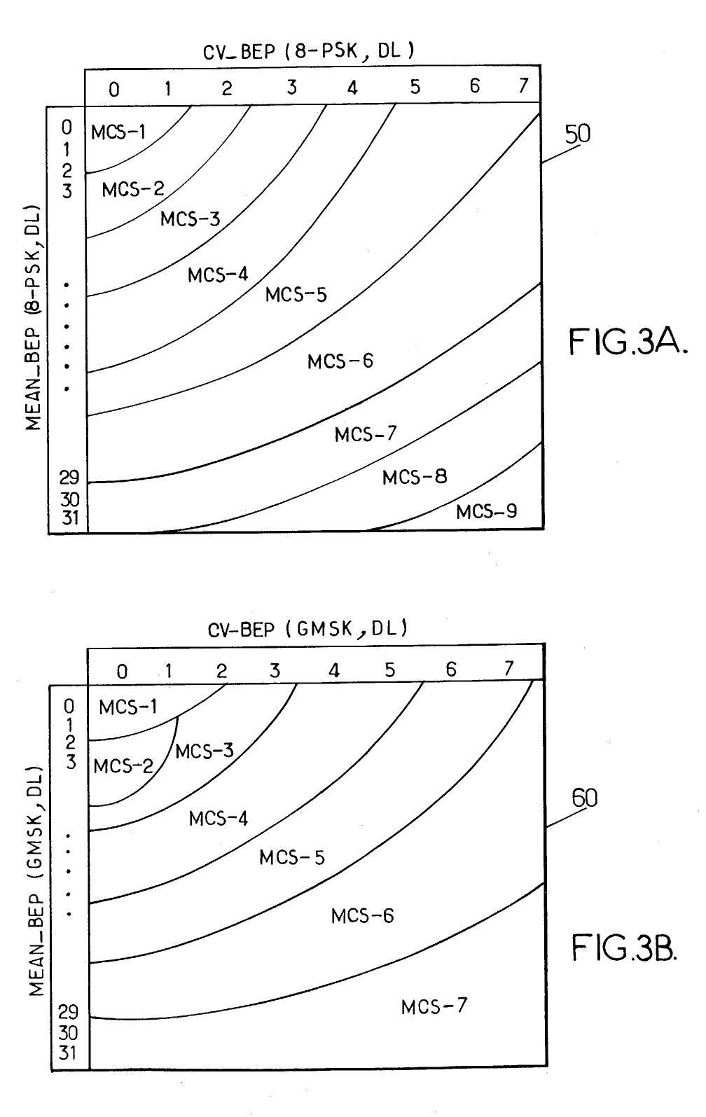

Schematized examples of such lookup tables are presented in FIGS. 3A and 3B. Table 50 represented in FIG. 3A is applied to a radio downlink (DL) using 8-PSK modulation, while table 60 represented in FIG. 3B is applied to the same radio downlink, but when it uses GMSK modulation.

Moreover, the PCU is capable of evaluating a block error rate for a radio link or a set of radio uplinks or downlinks. This may be carried out with the aid of the Automatic Repeat Request (ARQ) mechanism implemented in the RLC/MAC layer. For a set of RLC blocks transmitted, it can thus evaluate the proportion of blocks not received or poorly received by the recipient station. For the uplink blocks, it merely needs to base itself on the acknowledgement information which it formulates so as to return the latter to the mobile in the PACKET UPLINK ACK/NACK messages. For the downlink blocks, this acknowledgement information reaches it in the PACKET DOWNLINK ACK/NACK messages. The indicator corresponding to the proportion of blocks not received or poorly received is commonly called the BLER (Block Error Rate).

The BLER is strongly correlated with the concept of throughput. Specifically, the throughput is deduced from the BLER via the simplified formula: (1-BLER)×throughputₘₐₓ, where throughputₘₐₓ designates the maximum theoretical throughput on the radio link(s) considered, corresponding to the throughput indicated in the last column of table 1.

By taking the BLER into account in the criteria for choosing an MCS in respect of a radio links it is possible to optimize the throughput in a much more reliable manner than according to a straightforward analysis of the pair (MEAN_BEP, CV_BEP). Specifically, the BEP-related measurements are made at the binary level and depend on numerous parameters, such as the quality of the receiver and the propagation characteristics for given surroundings. The concept of erroneous blocks is much more concrete and more reliable insofar as it is related directly to the data elements transmitted. If a data block is erroneous, it must be retransmitted lest the quality of the communication be degraded.

Henceforth, nonlimitingly, the PCU is considered to maintain lookup tables and to calculate values of BLER on the scale of each BTS. Coming back to the example of FIG. 1, this signifies in particular that the PCU 22 calculates values of BLER for all the radio uplinks under the responsibility of the BTS 20b represented in FIG. 1, i.e. for the blocks sent by the MS 10a and 10b in communication with the BTS 20b. Furthermore, the PCU 22 calculates values of BLER for all the downlinks under the responsibility of the BTS 20b, i.e. for all the blocks sent by the BTS 20b.

More generally, and according to an advantageous embodiment of the inventions the PCU 22 calculates values of up and down BLER for each set of radio links having an activated given MCS. One thus obtains, at the level of the PCU 22, a set of values of BLER for each MCS active in the uplink direction, and another for each MCS active in the downlink direction. Advantageously, values of BLER will be calculated for the same radio links as those for which a lookup table is stored and maintained by the PCU (i.e., for example, for all the links under the dependence of a BTS in the case envisaged hereinabove).

Here, in a nonrestrictive manner, the standpoint of the downlink direction is adopted. The PCU 22 performs a statistical analysis of the BLER values calculated regularly for each MCS activated on the radio downlinks between the BTS 20b and the MSs 10b and 10c respectively. Let us consider for example that adjacent MCSs are used: for example, the link with the MS 10b uses MCS-1 and the MS 10c uses MCS-2. Values of BLER are available to the PCU 22 in respect of the blocks sent by the BTS 20b, for MCS-1 and MCS-2, and it utilizes them in such a way as to deduce statistical parameters therefrom. For example, it computes a statistical distribution of the estimated BLER values, i.e. calculates the occurrence of each estimated BLER value.

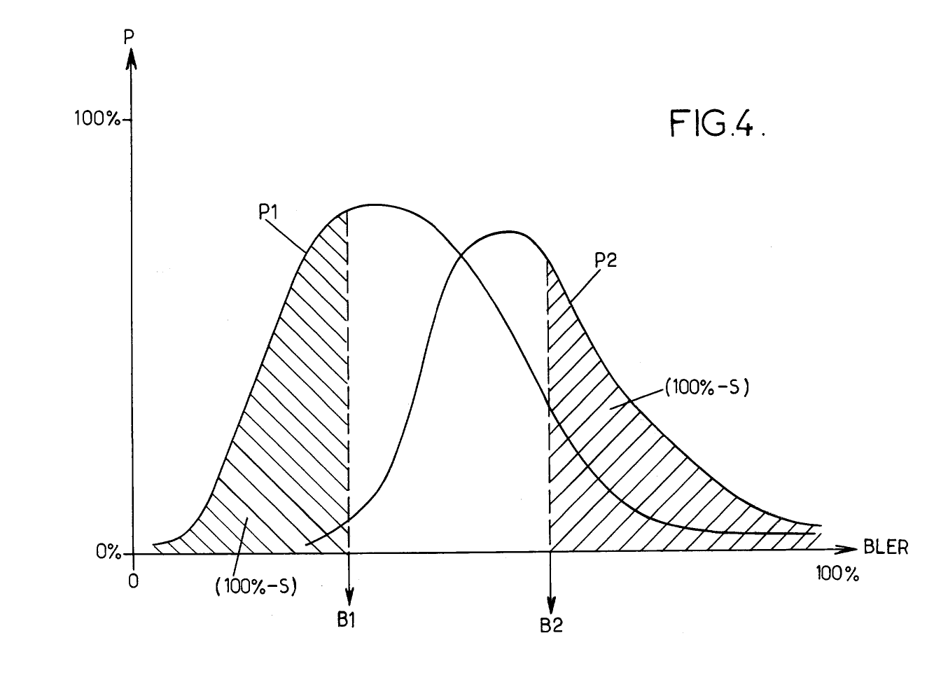

FIG. 4 illustrates examples of statistical curves computed by the PCU 22 from a defined number of samples of measurements of BLER for MCS-1 (P1) and MCS-2 (P2). These curves therefore convey, for a given MCS-n (with n=1 or 2), the probability of occurrence of the various values of BLER. MCS-1 being more robust with regard to transmission errors, it is logical for the BLER values measured on the downlink between the BTS 20b and the MS 10b to be smaller overall than those measured for MCS-2.

The PCU 22 then seeks to define a threshold value which determines the change of MCS. By way of example, one chooses to define the transition between two MCSs as follows: the location, in the lookup table, where the MCS offering the highest throughput is recommended for all the values, or failing this, a maximum of values, of CV_BEP for a minimum MEAN_BEP. Let us consider the threshold value characterizing the transition between MCS-1 and MCS-2. It is consistent with a value of BEP, such as defined previously.

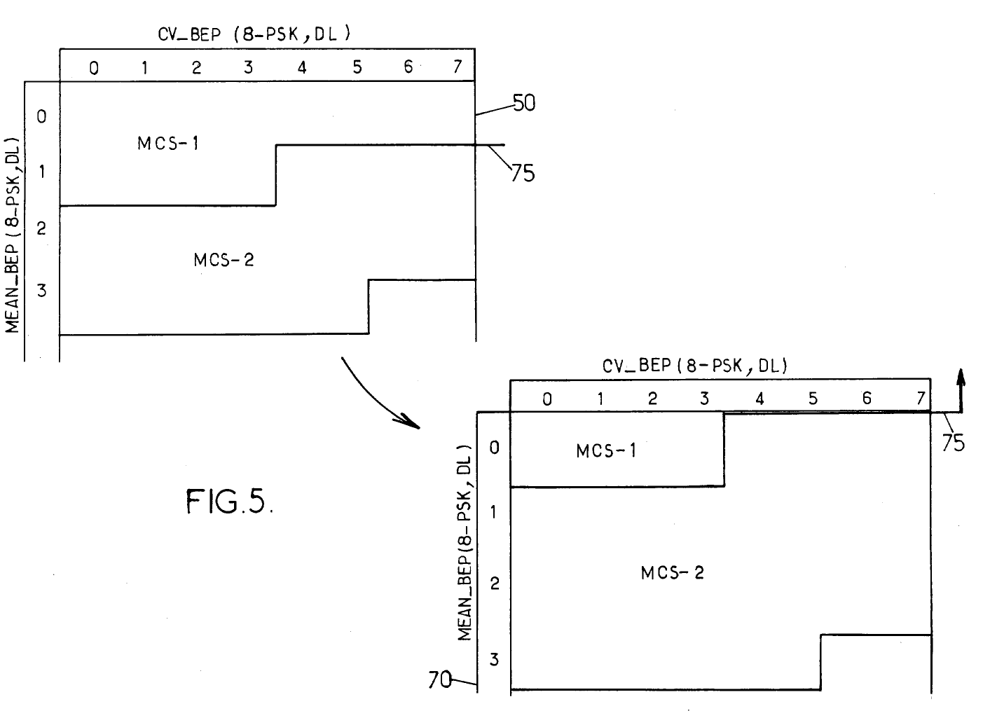

For example, the transition between MCS-1 and MCS-2 used by the PCU 22 in its lookup table 50, represented in FIG. 5, appears for a MEAN_BEP equal to 2 (where MCS-2 is recommended for all the values of MEAN_BEP and CV-BEP). The threshold value corresponding to this transition lies between 20.9% (=10^{-0.68}) and 22.9% (=10^{-0.64}) approximately, in accordance with the coding of the MEAN_BEP used for an 8-PSK modulation described in the aforesaid TS 100 911 technical specification.

To update such a threshold value T1 characterizing the transition between MCS-1 and MCS-2 for example, the PCU can for example calculate an average value of BLER (B1) above which the proportion of samples of BLER for MCS-1 is equal to a fixed percentage S. In parallel with this, the PCU defines from the distribution of the samples of values of BLER for MCS-2, a second average value of BLER (B2) below which S% of the measured samples lie. The hatched parts in FIG. 4 show the delimitations obtained by virtue of the values B1 and B2.

The PCU 22 deduces from the values of BLER B1 and B2, two values of respective throughputs D1 and D2. Specifically, depending on the maximum theoretical throughputs offered by MCS-1 and MCS-2, we have:

D1=(100%−B1)×8.8 (kbit/s)

D2=(100%−B1)×11.2 (kbit/s)

The PCU 22 then calculates the parameter C=D1/D2−1, representative of a relative difference between the throughputs thus calculated. The parameter C also conveys the overlap between the portions of the distributions as illustrated in FIG. 4. The PCU then compares the parameter C with a threshold X1. The value of the latter can for example be obtained by means of simulations. When C has a value greater than the threshold X1, this conveying a high overlap of the BLER distributions for MCS-1 and MCS-2, the threshold value T1 can be decreased by a fixed value δ. Specifically, in such a case, the actual throughputs offered by MCS-1 being close to or even better than those offered by MCS-2, it is legitimate to want to increase the use of MCS-1. Conversely, when C is less than −X1, this conveying a small overlap of the BLER distributions for MCS-1 and MCS-2, T1 may be increased by a fixed value, possibly equal to δ, so as to favor the use of MCS-2 for high BEP values and thus increase the throughput offered.

The threshold value T1 thus updated corresponds to a new value of transition in the lookup table concerned at the PCU 22. Let us take for example the case of a decrease in T1 following the analysis of the distributions of the BLERs for MCS-1 and MCS-2 exhibiting a small overlap. If the value of T1 goes to 24% for example, it is then within the bracket of values covered by MEAN_BEP=1 (from 22.9 to 25.1% approximately) . This signifies that the transition between the use of MCS-1 and MCS-2 may be made when values of MEAN_BEP=1 are calculated.

FIG. 5 illustrates this principle. It represents the upper part of the lookup table 50, already presented. The transition between MCS-1 and MCS-2 is made for MEAN_BEP=2, according to the definition adopted above. After calculating the BLER distributions, the PCU 22 determines, as described above, a new value of threshold between MCS-1 and MCS-2, of the order of 24%. In accordance with the coding of the MEAN_BEPs, the transition between MCS-1 and MCS-2 must then be made for MEAN_BEP=1. To this end, the PCU 22 modifies table 50 to obtain a new table 70 each inter-MCS transition of which is kept as compared with table 50, with the exception of the transition between MCS-1 and MCS-2 which is henceforth done for MEAN_BEP =1. This therefore corresponds to a simple translation of line in the lookup table concerned, as shown by FIG. 5. The line 75 represented in FIG. 5 symbolizes the transition between MCS-1 and MCS-2. It is therefore translated as its stands, upward, during the implementation of the lookup table 70, thus reducing the use of the MCS-1 scheme in favor of MCS-2.

On completion of this modification, the PCU 22 will use the new table 70 to determine the MCSs to be assigned to the various radio links to which the lookup table is applied, i.e., in our example, the radio downlinks between the BTS 20b and the MSs 10b and 10c.

Of course, many other methods of updating the lookup tables may be carried out on the basis of values BLER. It is for example possible to envisage the PCU estimating straightforwardly, for a set of radio links and for each MCS used, an average value of BLER which it updates with each new estimation of BLER or on the completion of a time period. The difference between the BLER averages estimated for two MCSs, for example MCS-1 and MCS-2, may then serve as basis as previously for modifying the value of transition between the two MCSs.

1. A method for adapting radio links supporting signals, representing data blocks composed of symbols, transmitted between base stations and mobile stations by applying a transmission errors protection scheme selected from a plurality of specified protection schemes, wherein at least some of said stations communicate to a control unit measurement values relating to errors observed in the reception of symbols transmitted, and the control unit consults at least one lookup table to adaptively select the protection scheme applied to each radio link as a function of the measurement values communicated in relation to said link, the method comprising the steps of:
for at least one of the protection schemes, estimating statistical parameters relating to errors observed in the reception of blocks transmitted by applying said protection scheme; and
processing the estimated statistical parameters to update the lookup table.

2. The method as claimed in claim 1, wherein the symbols consist of bits and wherein said measurement values relating to errors observed in the reception of symbols transmitted comprise values of an averaged bit error rate.

3. The method as claimed in claim 1, wherein the symbols consist of bits and wherein said measurement values relating to errors observed in the reception of symbols transmitted comprise values of a bit error probability variation parameter.

4. The method as claimed in claim 1, wherein said transmission errors protection schemes comprise a coding of the data blocks, selected from a plurality of possible error correcting codings.

5. The method as claimed in claim 1, wherein said transmission errors protection schemes comprise a modulation of the signals transmitted, said modulation being selected from a plurality of possible modulations.

6. The method as claimed in claim 5, wherein at least some of said stations communicate to the control unit measurement values relating to errors observed in the reception of symbols transmitted for each of the modulations, and wherein the control unit stores at least one lookup table for each modulation.

7. The method as claimed in claim 1, wherein said statistical parameters are estimated for a set of radio links between a base station and a group of mobile stations.

8. The method as claimed in claim 1, wherein said processing of the statistical parameters comprises the steps of:
determining, for at least two of the protection schemes, a distribution of the values of the statistical parameters relating to errors observed in the reception of blocks transmitted by applying the respective protection scheme, as a function of the occurrence of said values;
calculating a value of a parameter representative of an overlap between the distributions for the two protection schemes; and
tailoring the presence of the two protection schemes with respect to one another in the lookup table as a function of said value of the parameter representative of the overlap between the distributions.

9. The method as claimed in claim 8, wherein the protection schemes are ranked by ascending order as a function of a theoretical throughput offered and wherein said two protection schemes are consecutive in the ranking.

10. A control unit for a radio communication system affording radio links supporting signals, representing data blocks composed of symbols, transmitted between base stations and mobile stations by applying a transmission errors protection scheme selected from a plurality of specified protection schemes, the control unit comprising:
means for receiving, from certain at least of said stations, measurement values relating to errors observed in the reception of symbols transmitted;
means for consulting at least one lookup table for adaptively selecting the protection scheme applied to each radio link as a function of the measurement values received in relation to said link;
means for estimating, for at least one of the protection schemes, statistical parameters relating to errors observed in the reception of blocks transmitted by applying said protection scheme; and
means for updating the lookup table on the basis of the estimated statistical parameters.

11. The control unit as claimed in claim 10, wherein the symbols consist of bits and wherein said measurement values relating to errors observed in the reception of symbols transmitted comprise values of an averaged bit error rate.

12. The control unit as claimed in claim 10, wherein the symbols consist of bits and wherein said measurement values relating to errors observed in the reception of symbols transmitted comprise values of a bit error probability variation parameter.

13. The control unit as claimed in claim 10, wherein said transmission errors protection schemes comprise a coding of the data blocks, selected from a plurality of possible error correcting codings.

14. The control unit as claimed in claim 10, wherein said transmission errors protection schemes comprise a modulation of the signals transmitted, said modulation being selected from a plurality of possible modulations.

15. The control unit as claimed in claim 14, wherein the means for receiving measurement values are arranged to receive measurement values relating to errors observed in the reception of symbols transmitted for each of the modulations, at least one lookup table being stored for each modulation.

16. The control unit as claimed in claim 10, wherein the means for estimating the statistical parameters are arranged to estimate statistical parameters for a set of radio links between a base station and a group of mobile stations.

17. The control unit as claimed in claim 10, wherein the means for updating the lookup table comprise:
means for determining, for at least two of the protection schemes, a distribution of the values of the statistical parameters relating to errors observed in the reception of blocks transmitted by applying the respective protection scheme, as a function of the occurrence of said values;
means for calculating a value of a parameter representative of an overlap between the distributions for the two protection schemes; and
means for tailoring the presence of the two protection schemes with respect to one another in the lookup table as a function of said value of the parameter representative of the overlap between the distributions.

18. The control unit as claimed in claim 17, wherein the protection schemes are ranked by ascending order as a function of a theoretical throughput offered and wherein said two protection schemes are consecutive in the ranking.
